(19) United States
(12) Patent Application Publication
(10) Pub. No.: US 2018/0085709 A1
(43) Pub. Date: Mar. 29, 2018

(54) WATER TREATMENT DEVICE, AND METHOD OF OPERATING WATER TREATMENT DEVICE

(71) Applicant: MITSUBISHI HEAVY INDUSTRIES, LTD., Tokyo (JP)

(72) Inventors: Hidemasa Kakigami, Tokyo (JP); Yoshiaki Ito, Tokyo (JP); Katsuhiko Yokohama, Tokyo (JP); Hideo Iwahashi, Tokyo (JP); Takayoshi Hori, Yokohama-shi (JP); Katsunori Matsui, Yokohama-shi (JP)

(73) Assignee: MITSUBISHI HEAVY INDUSTRIES, LTD., Tokyo (JP)

(21) Appl. No.: 15/557,934

(22) PCT Filed: Mar. 20, 2015
(86) PCT No.: PCT/JP2015/058550

§ 371 Date: Sep. 13, 2017

(51) Int. Cl. B01D 61/02; B01D 61/12; B01D 61/08; C02F 1/44

(52) U.S. Cl. CPC B01D 61/022; B01D 61/025; B01D 61/12; B01D 61/08; C02F 2103/08; B01D 2313/18; B01D 2317/04; B01D 2311/2634; B01D 2311/2642; C02F 1/441

(57) ABSTRACT

A water treatment device (1) includes a primary unit (U1) having a plurality of primary elements (E1) as reverse osmosis membrane devices disposed in parallel to each other to separate water to be treated (SW) into primary condensed water (CW1) and fresh water (FW1); a pump (P) which feeds the water to be treated (SW) to the primary unit (U1); a secondary unit (U2) having secondary elements (E2) as reverse osmosis membrane devices, the secondary elements (E2) being provided in smaller number than the primary elements (E1) and disposed in parallel to each other to separate the primary condensed water (W1) into secondary condensed water (CW2) and fresh water (FW2); and a switching unit (2) provided only in the secondary unit (U2) among the primary unit (U1) and the secondary unit (U2) to separate at least one of the plurality of secondary elements (E2) so that treatment is disabled.

### TECHNICAL FIELD

The present invention relates to a water treatment device and a method of operating the same.

### BACKGROUND ART

As a technique for performing desalination of sea water or purification of industrial water, a water treatment device using a reverse osmosis membrane has been put to practical use. As a specific example thereof, a technique described in the following Patent Literature 1 is known. The membrane treatment device described in Patent Literature 1 has a membrane module bank on an upstream stage side and a membrane module bank on a downstream stage side each having a plurality of membrane modules, and a pump which feeds raw water (water to be treated) to the membrane module bank on the upstream stage side.

In such a device, a target value is previously determined with respect to a ratio of fresh water (fresh water recovery rate) recovered from the water to be treated such as sea water. When the fresh water recovery rate is excessively high, the concentration of salt contained in the condensed water, which is a remaining component from which fresh water has been separated, excessively rises. When condensed water of a high salt concentration is discharged into the environment, there is concern about an increase in an environmental burden. Therefore, for example, when sea water is desalinated, the fresh water recovery rate is set to about 25 to 40%.

On the other hand, when the capability of the reverse osmosis membrane declines with the continuous operation of the device, the fresh water recovery rate relatively decreases. In this case, it is necessary to compensate for the decrease in the fresh water recovery rate by increasing the supply pressure of the water to be treated to the reverse osmosis membrane. When the output of the pump is increased to increase the fresh water recovery rate, the supply pressure of the water to be treated to the reverse osmosis membrane rises. As the pressure of the water to be treated rises, the amount of fresh water separated in the reverse osmosis membrane increases and the fresh water recovery rate starts to increase.

### CITATION LIST

### Patent Literature

### Patent Literature 1

Japanese Unexamined Patent Application, First Publication No. 2013-22544

### SUMMARY OF INVENTION

### Technical Problem

However, as the fresh water recovery rate rises as described above, the amount of condensed water separated from the water to be treated decreases. That is, in the device described in the above-mentioned Patent Literature 1, the amount of condensed water supplied from the membrane module bank on the upstream stage side to the membrane module bank on the downstream stage side decreases. Furthermore, in the device using the reverse osmosis membrane, a lower limit value is set for the amount of condensed water (flow rate) discharged per element. If the amount of condensed water falls below the lower limit value, defects such as scale precipitation occur due to an increase in membrane surface concentration caused by concentration polarization in the membrane module, and there is a possibility that sufficient separation and condensation cannot be performed. Therefore, in the device described in the above-mentioned Patent Literature 1, the fresh water recovery rate becomes limited.

The present invention has been made in view of the above circumstances, and an object thereof is to improve the fresh water recovery rate and the operation rate in the water treatment device.

### Solution to Problem

The present invention includes the following aspects in order to solve the above problem.

According to a first aspect of the present invention, a water treatment device includes a primary unit having a plurality of primary elements as reverse osmosis membrane devices disposed in parallel to each other to separate water to be treated into primary condensed water and fresh water; a pump which feeds the water to be treated to the primary unit; a secondary unit having secondary elements as reverse osmosis membrane devices, the secondary elements being provided in smaller number than the primary elements and disposed in parallel to each other to separate the primary condensed water into secondary condensed water and fresh water; and a switching unit provided only in the secondary unit among the primary unit and the secondary unit to separate at least one of the plurality of secondary elements so that treatment is disabled.

According to the above configuration, by increasing the output of the pump, the ratio of the fresh water collected from the secondary unit to the deposition of the water to be treated (fresh water recovery rate) increases. As the fresh water recovery rate increases, the amount of primary condensed water flowing into each secondary element decreases in the secondary unit.

Here, in the reverse osmosis membrane device such as the primary element and the secondary element, the lower limit value is set for the amount of condensed water to be introduced. In the water treatment device, when the amount of the primary condensed water decreases as described above, at least one secondary element is separated by the switching unit and the treatment is disabled. As a result, it is possible to guide the primary condensed water exceeding the lower limit value to the remaining secondary elements except the separated secondary elements.

According to a second aspect of the present invention, in the water treatment device according to the first aspect, at least one of the secondary elements may include an introduction line which guides the primary condensed water supplied from the primary unit to the secondary element, a secondary condensed water line through which the secondary condensed water separated from the primary condensed water flows, and a fresh water line through which the fresh water separated from the primary condensed water flows. The switching unit may have a second valve provided on the secondary condensed water line, a first valve provided on the fresh water line, and a third valve provided on the introduction line.

According to the above configuration, by closing each of the first valve, the second valve, and the third valve, it is possible to easily separate the specific secondary element. In particular, since the first valve, the second valve, and the third valve are used as the switching unit, it is possible to open and close the valve during the operation of the device. Therefore, the second element can be separated without stopping the water treatment device. In other words, it is possible to separate the secondary element, without lowering the operation rate of the water treatment device.

According to a third aspect of the present invention, the water treatment device according to the second aspect may include a preservative solution supply line provided between the third valve and the secondary element on the introduction line to guide the preservative solution supplied from the outside to the secondary element, a preservative solution discharge line provided between the second valve and the secondary element on the secondary condensed water line to discharge the preservative solution from the secondary element to the outside; and a fourth valve provided on the preservative solution discharge line.

According to the above configuration, it is possible to supply the preservative solution to the secondary element which is separated to disable the treatment. As a result, contamination of the reverse osmosis membrane in the secondary element can be reduced. Further, when returning the separated secondary element to the system again, by opening the fourth valve, the preservative solution may be discharged through the preservative solution discharge line. In addition, it is possible to supply and discharge the preservative solution only by opening and closing the valve, without stopping the water treatment device. As a result, it is possible to suppress degradation in the operation rate of the water treatment device.

According to a fourth aspect of the present invention, the water treatment device according to any one of the above-described aspects may further include a measuring unit which measures characteristic value of at least one of the water to be treated, the primary condensed water, the secondary condensed water, and the fresh water; and a control unit which controls the operation of the switching unit on the basis of a comparison between the characteristic value and a predetermined reference value.

According to a fifth aspect of the present invention, in the water treatment device according to the fourth aspect, the measuring unit may measure a temperature or electric conductivity in at least one of the water to be treated, the primary condensed water, the secondary condensed water, and the fresh water, and the control unit may include a calculating unit which calculates a Langeliar saturation index (LSI) as the characteristic value on the basis of the temperature or the electric conductivity.

According to the above configuration, it is possible to maximize the fresh water recovery rate using the water treatment device depending on the quality of water in at least one of the water to be treated, the primary condensed water, the secondary condensed water, and the fresh water. In particular, by providing the measuring unit and the control unit, the capability of the water treatment device against changes in water quality due to seasonal variations or the like can be autonomously adjusted, and thus it is possible to flexibly respond to the change.

According to a sixth aspect of the present invention, there is provided a method of operating the water treatment device for separating at least one secondary element from the water treatment device according to any one of the second to fifth aspects, the method including: closing the fresh water line by closing the first valve; closing the secondary condensed water line by closing the second valve after closing the first valve; and closing the introduction line by closing the third valve after closing the second valve.

According to the above method, the fresh water line is firstly closed by closing the first valve. Thereby, the discharge of fresh water is stopped. At this time, the primary condensed water is discharged from the secondary element which is the subject of separation through the secondary condensed water line, without being substantially condensed. Thereafter, by closing the third valve, introduction of the primary condensed water to the secondary element is also stopped. As a result, it is possible to suppress scale precipitation in the secondary element.

On the other hand, if the second valve is closed prior to the closing of the first valve, since the high-pressure primary condensed water is continuously supplied to the secondary element, a high load is applied to the secondary element. In other words, the primary condensed water is excessively condensed in the secondary element. As a result, there is a possibility that salts contained in the primary condensed water may precipitate as scale in the secondary element. However, according to the operation method as described above, separation and condensation of the secondary element is disabled by first stopping the discharge of fresh water. Therefore, scale precipitation can be sufficiently suppressed.

### Advantageous Effects of Invention

According to the water treatment device and the method of operating the water treatment device of the present invention, it is possible to improve the fresh water recovery rate and the operation rate.

### BRIEF DESCRIPTION OF DRAWINGS

FIG. 1 is a system diagram illustrating a water treatment device according to a first embodiment of the present invention.

FIG. 2 is a process chart illustrating a method of operating the water treatment device according to the embodiment of the present invention.

FIG. 3 is a system diagram illustrating a water treatment device according to a second embodiment of the present invention.

FIG. 4 is a system diagram illustrating a water treatment device according to a modified example of the present invention.

### DESCRIPTION OF EMBODIMENTS

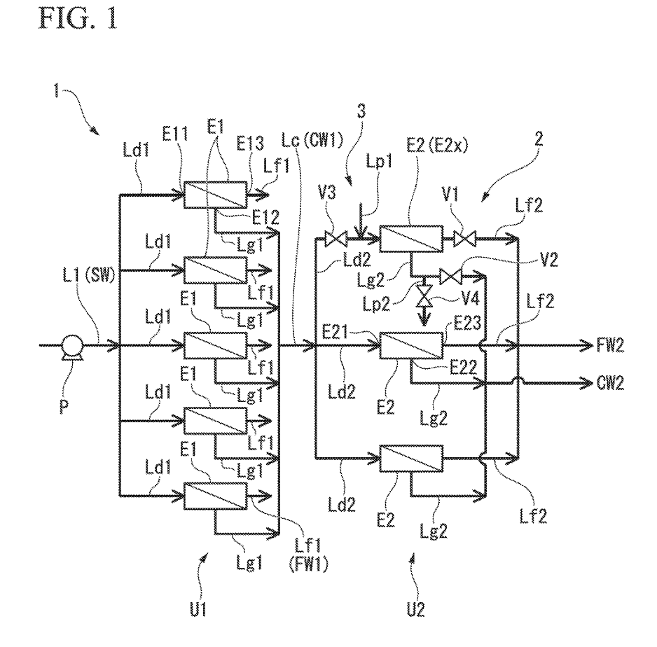

A first embodiment of the present invention will be described with reference to the drawings. As illustrated in FIG. 1, a water treatment device 1 according to the present embodiment includes a water intake line L1 through which water to be treated SW flows, a pump P which feeds the water to be treated SW from the upstream to the downstream of the water intake line L1, a primary unit U1 and a secondary unit U2 having a plurality of reverse osmosis membrane devices (a primary element E1, and a secondary element E2), and a connection line Lc which connects the primary unit U1 and secondary unit U2 to each other. Furthermore, the water treatment device 1 has a switching unit 2 which separates the secondary element E2 in the secondary unit U2 so that the treatment is disabled, and a preservative solution supply device 3 which supplies the preservative solution to the separated secondary element E2.

The water intake line L1 is a flow path which guides the water to be treated SW supplied from the outside to the water treatment device 1. On the upstream side of the water intake line L1, for example, a pretreatment device (not illustrated) is provided. In the pretreatment device, addition of an oxidizing agent for suppressing organisms contained in sea water from adhering to the device, or a flocculant for aggregating fine particles, colloids and the like, and adjustment of pH and the like are performed. More specifically, hypochlorous acid or the like is preferably used as the oxidizing agent. Further, an inorganic flocculant such as ferric chloride or a polymer flocculant such as PAC is used as the flocculant. The suspension agglomerated by the flocculant is removed by a sand filter.

The water to be treated SW subjected to the pretreatment as described above is fed from the upstream side toward the downstream side in the water intake line L1, by the pump P provided on the water intake line L1.

The primary unit U1 and the secondary unit U2 are devices for separating and condensing the water to be treated SW guided by the water intake line L1 by reverse osmosis. The primary unit U1 includes a plurality of primary elements E1 disposed in parallel to each other, a primary distribution line Ld1 which distributes the water to be treated SW in the water intake line L1 to the plurality of primary elements E1, and a primary water collection line Lg1 and a primary fresh water line Lf1 through which the primary condensed water CW1 and the fresh water (primary fresh water FW1) discharged from the primary element E1 flow, respectively.

The primary element E1 is a reverse osmosis membrane device including a reverse osmosis membrane (RO membrane) such as a hollow fiber membrane or a spiral membrane therein. Each of the primary elements E1 mainly includes an exterior member called a vessel, and a reverse osmosis membrane disposed inside the vessel. Furthermore, a primary flow inlet E11 connected to the distribution line, and a primary water collection port E12 and a primary fresh water collection port E13 connected to the primary water collection line Lg1 and the primary fresh water line Lf1, respectively, are provided in the vessel.

The primary unit U1 is configured by disposing the primary elements E1 in parallel to each other. As an example, in the present embodiment, five primary elements E1 are disposed in parallel. More specifically, the downstream end portion of the water intake line L1 and the primary flow inlet E11 of each primary element E1 are connected to each other by the distribution line. Further, the primary water collection line Lg1 connects the primary water collection port E12 of each primary element E1 and the upstream end portion of the connection line Lc (to be described later) to each other. The primary fresh water line Lf1 is a flow path for discharging and collecting fresh water separated in each primary element E1 to the outside. On the downstream side of the primary fresh water line Lf1, a tank for storing the recovered fresh water or facilities for performing further filtering etc. are connected (neither is illustrated).

The secondary unit U2 is a device for further separating and condensing the primary condensed water CW1 generated in the primary unit U1 by the same configuration as the primary unit U1. More specifically, the secondary unit U2 has a plurality of secondary elements E2 disposed in parallel to each other, a secondary distribution line Ld2 (introduction line) which distributes the primary condensed water CW1 generated in the primary unit U1 to the plurality of secondary elements E2, and a secondary water collection line Lg2 (secondary condensed water line) and a secondary fresh water line Lf2 (fresh water line) through which the secondary condensed water CW2 discharged from the secondary element E2 and the fresh water (secondary fresh water FW2) flow, respectively.

The secondary element E2 is a reverse osmosis membrane device having the same configuration and capability as the above-mentioned primary element E1, but they are distinguished in the following description. In the vessel of the secondary element E2, a secondary flow inlet E21 connected to the secondary distribution line Ld2, and a secondary water collection port E22 and a secondary fresh water collection port E23 connected to each of the secondary water collection line Lg2 and the secondary fresh water line Lf2 are provided.

Similarly to the primary unit U1, the secondary unit U2 is configured by disposing a plurality of secondary elements E2 in parallel to each other. The number of secondary elements E2 in the secondary unit U2 is set to be smaller than the number of primary elements E1 in the primary unit U1. In the present embodiment, three secondary elements E2 are provided in the secondary unit U2.

The connection line Lc connects the downstream side of the primary unit U1 and the secondary unit U2. More specifically, the connection line Lc connects the downstream end portion of each primary water collection line Lg1 in the primary unit U11 and the upstream end portion of each secondary distribution line Ld2 in the secondary unit U2. Thereby, as the primary condensed water CW1 generated in the primary unit U1 flows in the order of the primary water collection line Lg1, the connection line Lc, and the secondary distribution line Ld2, the primary condensed water CW1 is distributed to each secondary element E2 of the secondary unit U2. In the secondary element E2, the primary condensed water CW1 is further separated and condensed to generate fresh water (secondary fresh water FW2) and secondary condensed water CW2 as the remaining components except the secondary fresh water FW2. Fresh water is recovered through the secondary fresh water line Lf2. The secondary condensed water CW2 is recovered through the secondary water collection line Lg2 and then discharged to the outside after undergoing post-treatment or the like by an external facility (not illustrated).

Furthermore, in the water treatment device 1 according to the present embodiment, there is provided a switching unit 2 which separates one secondary element E2 in the secondary unit U2 from the system. In the following description, among the three secondary elements E2, the secondary element E2 provided with the switching unit 2 is referred to as a switchable secondary element E2x.

More specifically, the switching unit 2 has three valves (a first valve V1, a second valve V2, and a third valve V3) provided in each line of the switchable secondary element E2x. By adjusting the opening degree of these valves, it is possible to switch the circulation state (opening and closing states) of each line.

The first valve V1 is provided on the secondary fresh water line L12 in the switchable secondary element E2x. Thereby, the circulation state of the secondary fresh water FW2 flowing through the secondary fresh water line L12 is adjusted. The second valve V2 is provided on the secondary water collection line Lg2 in the switchable secondary element E2x. Thereby, the circulation state of the secondary condensed water CW2 flowing through the secondary water collection line Lg2 is adjusted. The third valve V3 is provided on the secondary distribution line Ld2 in the switchable secondary element E2x. Thereby, the circulation state of the primary condensed water CW1 flowing through the secondary distribution line Ld2 is adjusted.

By closing each of the first valve V1, the second valve V2, and the third valve V3, the respective lines are closed. Thereby, the supply of the primary condensed water CW1 to the switchable secondary element E2x and the discharge of the secondary fresh water FW2 and the secondary condensed water CW2 from the switchable secondary element E2x are stopped to disable the treatment. That is, the switchable secondary element E2x is in a state of being separated from the system.

Furthermore, in the water treatment device 1 according to the present embodiment, a preservative solution supply device 3 which supplies preservative solution to the separated secondary element E2 is provided. The device supplies preservative solution to the switchable secondary element E2x separated from the system by the switching unit 2. In the separated switchable secondary element E2x, since no water flows through the reverse osmosis membrane, condensed water remains in a state of being retained. If such a state continues for a long time, there is a possibility that the capability of the reverse osmosis membrane in the secondary element E2 may be degraded due to deterioration or corrosion of the condensed water. Therefore, in the water treatment device 1, by supplying the preservative solution into the secondary element E2 by the preservative solution supply device 3, the secondary element E2 is protected.

Specifically, the preservative solution supply device 3 includes a preservative solution supply line Lp1 connected to the secondary distribution line Ld2 in the switchable secondary element E2x, a preservative solution discharge line Lp2 connected to the secondary water collection line Lg2, and a fourth valve V4 for adjusting the circulation state of the preservative solution discharge line Lp2.

The preservative solution supply line Lp1 connects a tank (not illustrated) for storing the preservative solution and a region between the third valve V3 and the secondary element E2 (secondary flow inlet E21) on the secondary distribution line Ld2. The preservative solution in the tank is supplied into the secondary distribution line Ld2 through the preservative solution supply line Lp1. Further, the preservative solution discharge line Lp2 extends toward the outside from the region between the second valve V2 and the secondary element E2 on the secondary water collection line Lg2. By opening the fourth valve V4, the primary condensed water CW1 staying in the switchable secondary element E2x and the surplus component of the preservative solution are extruded to the outside, respectively.

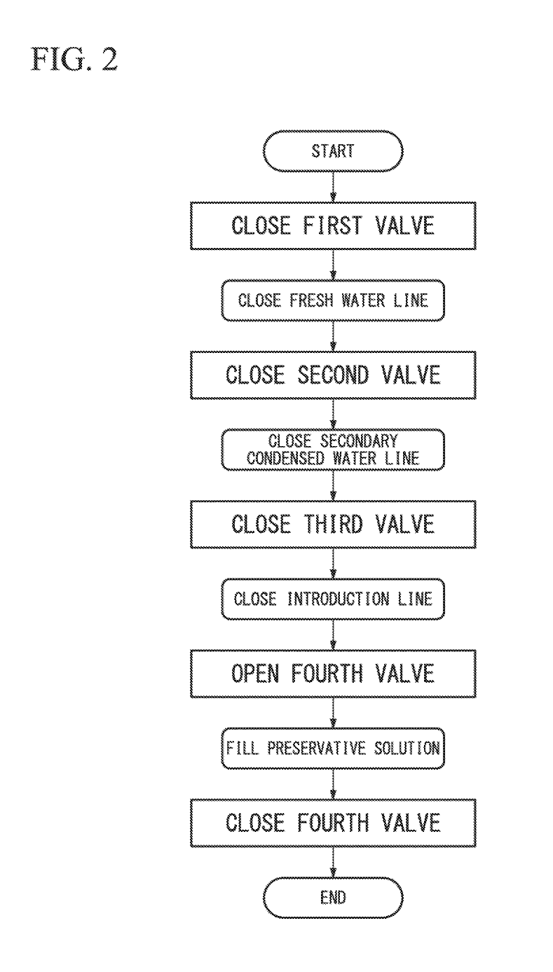

Next, a method of operating the water treatment device 1 configured as described above will be described with reference to FIG. 1 or FIG. 2.

In the normal operation state, all of the first valve V1, the second valve V2, and the third valve V3 in the switching unit 2 are opened. On the other hand, the fourth valve V4 is closed. By driving the pump P in this state, the water to be treated SW is guided to the primary unit 11U via the water intake line L1. The water to be treated SW pressurized by the pump P flows through the reverse osmosis membrane of each primary element E1 under high pressure.

In the primary unit U1, reverse osmosis with respect to the water to be treated SW is performed in each primary element E1. As a result, in the primary element E1, the primary condensed water CW1 in which salt or the like in the water to be treated SW is condensed, and the primary fresh water FW1 as remaining components (fresh water) except the primary condensed water CW1 are generated. More specifically, the fresh water component of the water to be treated SW is transmitted through the reverse osmosis membrane and reaches the downstream side to become the primary fresh water FW1. As the primary fresh water FW1 is transmitted to the downstream side, salt contained in the water to be treated SW is condensed on the upstream side of the reverse osmosis membrane. As a result, the primary condensed water CW1 is generated on the upstream side of the reverse osmosis membrane. At the downstream side of the reverse osmosis membrane, the pressure of the primary fresh water FW1 becomes smaller than the pressure of the water to be treated SW.

The primary fresh water FW1 is recovered to the outside via the primary fresh water line Lf1. The primary condensed water CW1 is collected in the primary water collection line Lg1 and then flows into the secondary unit U2 on the downstream side via the connection line Lc. In the secondary unit U2, the primary condensed water CW1 flowing in via the connection line Lc is distributed to each secondary element E2 by the secondary distribution line Ld2, respectively.

Similarly to the primary element E1, in the secondary element E2, separation of fresh water from the primary condensed water CW1 and condensation of salts are performed. That is, the secondary fresh water FW2 which is a fresh water component in the primary condensed water CW1, and the secondary condensed water CW2 which is the remaining component except the secondary fresh water FW2 are generated.

The secondary fresh water FW2 is recovered to the outside by the secondary fresh water FW2 collection line. The secondary condensed water CW2 is collected in the secondary water collection line Lg2 and then discharged into the external environment. By continuously performing the above operations, the water to be treated SW (sea water) is desalinated.

In the water treatment device 1 as described above, a target value is predetermined with respect to a volume ratio of the fresh water recovered from the water to be treated SW (fresh water recovery rate). For example, when sea water is desalinated, the fresh water recovery rate is set to about 25 to 40%. However, when the capability of the reverse osmosis membrane deteriorates with the continuous operation of the device, the fresh water recovery rate relatively decreases and may fall below the target value. In this case, by increasing the output of the pump P, the supply pressure of the water to be treated SW to the reverse osmosis membrane increases. As the pressure of the water to be treated SW increases, the amount of fresh water separated in the reverse osmosis membrane increases, and the fresh water recovery rate starts to rise.

However, as the fresh water recovery rate rises as described above, the amount of the secondary condensed water CW2 separated from the water to be treated SW decreases. That is, the amount of the condensed water discharged from each element of the secondary unit U2 decreases. Here, in the device using the reverse osmosis membrane, the lower limit value is set for the amount (flow rate) of condensed water to be discharged from each element. When the amount of the condensed water falls below the lower limit value, defects such as scale precipitation occur due to the concentration polarization in the secondary unit U2 (secondary element E2), and there is a possibility that sufficient separation and condensation cannot not be performed.

Therefore, in the water treatment device 1 according to the present embodiment, by separating the switchable secondary element E2x from the system by the above-described switching unit 2, the amount of condensed water per each element of the remaining secondary elements E2 except the switchable secondary element E2x is relatively increased. Therefore, the amount of the secondary condensed water discharged from each of the secondary elements E2 can be made larger than the lower limit value.

More specifically, as illustrated in FIG. 2, as method of operating the water treatment device 1 for separating the switchable secondary element E2x, a step of closing the first valve V1, a step of closing the second valve V2, and the step of closing the third valve V3 are performed in the aforementioned order. First, by closing the first valve V1, the circulation of the secondary fresh water FW2 in the secondary fresh water line Lf2 (fresh water line) is stopped. Subsequently, by closing the second valve V2 after closing the first valve V1, the circulation of the secondary condensed water CW2 in the secondary water collection line Lg2 (secondary condensed water CW2 line) is stopped. Next, by closing the third valve V3 after closing the second switching valve V2, the secondary water collection line Lg2 is stopped. As a result, the supply of the primary condensed water CW1 through the secondary water collection line Lg2 is stopped.

As a result, the switchable secondary element E2x is separated from the other secondary element E2. At this time, the primary condensed water CW1 temporarily stays in the switchable secondary element E2x.

Next, the fourth valve V4 on the preservative solution discharge line Lp2 is opened. As a result, the preservative solution is filled into the switchable secondary element E2x through the preservative solution supply line Lp1. That is, the primary condensed water CW1 staying in the switchable secondary element E2x is extruded and discharged to the outside by the preservative solution through the preservative solution discharge line Lp2. As described above, the interior of the switchable secondary element E2x is in the state of being filled with the preservative solution. After it is checked that the filling of the preservative solution is completed, the fourth valve V4 is closed.

As described above, in the water treatment device 1 according to the present embodiment, by increasing the output of the pump P, the amounts of fresh water recovered from the primary unit U1 and the secondary unit U2 increase, respectively. When the fresh water recovery rate increases, the amount of the secondary condensed water CW2 discharged from each of the secondary elements E2 in the secondary unit U2 decreases.

Generally, in the reverse osmosis membrane device, a lower limit value is set for the amount of condensed water discharged from each element. In the water treatment device 1 according to the present embodiment, when the amount of the secondary condensed water CW2 decreases as described above, at least one secondary element E2 is separated by the switching unit 2 to disable the treatment. Thereby, the secondary condensed water CW2 exceeding the above-mentioned lower limit value can be guided to the remaining secondary elements E2 except the separated secondary element E2 (switchable secondary element E2x).

Further, separation of the switchable secondary element E2x can be easily performed by closing the first valve V1, the second valve V2, and the third valve V3, respectively. In addition, the first valve V1, the second valve V2, and the third valve V3 can be opened and closed, during water flow (operation) of the water treatment device 1. That is, in the water treatment device 1 according to the present embodiment, it is possible to separate the switchable secondary element E2x, without stopping the operation. Thus, the secondary element E2 can be separated, without lowering the operation rate of the water treatment device 1, and as a result, the maximum value of the fresh water recovery rate can be improved.

Here, for example, in the case of adopting a configuration in which some of the secondary element E2 is separated from the system by closing the secondary elements E2 with a plug, in place of the switching unit 2 as described above, there is a need to stop the water flow (operation of the device) at the time of installation of the plug. In contrast, in the water treatment device 1 according to the present embodiment, since the above-described switching unit 2 is used, it is possible to separate the switchable secondary element E2x, without stopping the operation of the water treatment device 1. This makes it possible to avoid a decrease in the operation rate of the water treatment device 1.

Also, preservative solution is supplied to the switchable secondary element E2x which is separated to disable the treatment. Since the primary condensed water CW1 is extruded to the outside by filling of the preservative solution, contamination of the secondary element E2 can be reduced. Furthermore, in the case of returning the switchable secondary element E2x to the system again, by opening the fourth valve V4, preservative solution can be easily discharged through the preservative solution discharge line Lp2. That is, it is possible to supply and discharge the preservative solution only by opening and closing the valve, without stopping the water treatment device 1. As a result, it is possible to further suppress the decrease in the operation rate of the water treatment device 1.

Furthermore, according to the method of operating the water treatment device 1, when separating the switchable secondary element E2x, first by closing the first valve V1, the fresh water line is closed. As a result, the discharge of fresh water is stopped. At this time, the primary condensed water CW1 is discharged through the secondary condensed water CW2 line from the secondary element E2 which is the subject of separation, without being substantially condensed. Thereafter, the introduction of the primary condensed water CW1 to the secondary element E2 is also stopped by closing the third valve V3. As a result, it is possible to suppress the scale precipitation in the switchable secondary element E2x.

On the other hand, when the second valve V2 is closed prior to closing of the first valve V1, since the high-pressure primary condensed water CW1 is continuously supplied to the switchable secondary element E2x, a high load is applied to the switchable secondary element E2x. In other words, the primary condensed water CW1 is excessively condensed in the switchable secondary element E2x. As a result, there is a possibility that salts contained in the primary condensed water CW1 may precipitate as scale. However, according to the operation method as described above, since the discharge of the fresh water (the secondary fresh water FW2) is stopped first, separation and condensation in the switchable secondary element E2x become impossible. Therefore, scale precipitation can be sufficiently suppressed.

The first embodiment of the present invention has been described with reference to the drawings. However, the above configuration is merely an example, and various design changes can be made.

### Second Embodiment

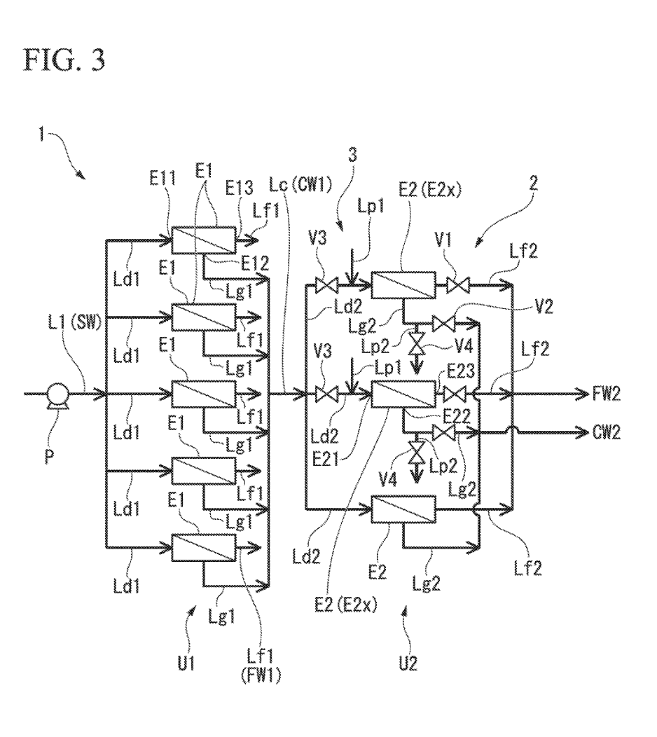

Next, a second embodiment of the present invention will be described with reference to FIG. 3. The same configurations as the aforementioned first embodiment are denoted by the same reference numerals, and a detailed description thereof will not be provided.

As illustrated in FIG. 3, in the water treatment device 1 according to the present embodiment, each of the two secondary elements E2 in the secondary unit U2 is the switchable secondary element E2x. Further, the switching unit 2 (the first valve V1, the second valve V2, and the third valve V3) and the preservative solution supply device 3 are provided in each of these two switchable secondary elements E2x. That is, the water treatment device 1 according to the present embodiment is configured so that the two secondary elements E2 can be individually separated.

Both the two switchable secondary elements E2x are separated from the system, by repeating the same steps as those described in the first embodiment. That is, in one of the two switchable secondary elements E2x, after sequentially closing each of the first valve V1, the second valve V2, and the third valve V3, by opening and closing the fourth valve V4, separation of the switchable secondary element E2x and filling of the preservative solution are performed.

In this way, after separating one switchable secondary element E2x, if the condensed water amount of the secondary element E2 still remains below the lower limit value, by further separating the other switchable secondary element E2x, it is possible to ensure a sufficient amount of secondary condensed water in each secondary element E2. That is, in the water treatment device 1 according to the present embodiment, since the two switchable secondary elements E2x are provided, it is possible to further increase the output of the pump P as compared with the above-described first embodiment. This makes it possible to further improve the fresh water recovery rate of the water treatment device 1 and its maximum value.

In the above embodiment, an example in which the two secondary elements E2 among the three secondary elements E2 are used as the switchable secondary element E2x has been described. However, the number of switchable secondary elements E2x is not limited, and all three secondary elements E2 may be set, for example, as switchable secondary elements E2x. That is, at least one secondary element E2 in the secondary unit U2 may be separated. In this way, as the number of the switchable secondary elements E2x increases, the upper limit value of the fresh water recovery rate can be further improved.

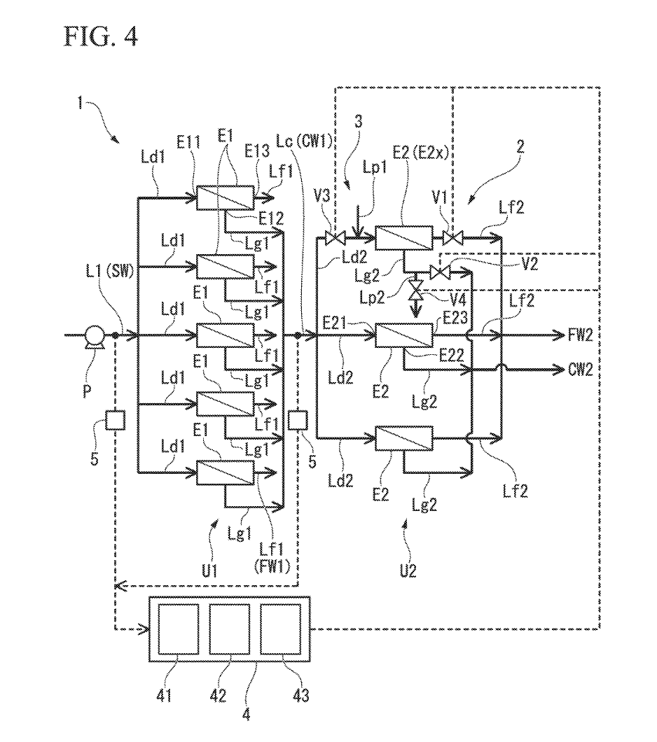

Furthermore, when operating the switching unit 2 and the preservative solution supply device 3 in each of the above-described embodiments, the operation may be performed by the operator's hand or may be performed by the control unit 4 as illustrated in FIG. 4. In the case of using the control unit 4, by providing the measuring unit 5 on the water intake line L1 and the connection line Lc, characteristic values of water (water to be treated SW, primary condensed water CW1, secondary condensed water CW2, primary fresh water FW, and secondary fresh water FW2) in each line are measured. On the basis of the characteristic values, the control unit 4 controls the switching unit 2 (opening and closing of the first valve V1, the second valve V2, and the third valve V3).

More specifically, as the measuring unit 5, a device capable of measuring the electric conductivity of water, a thermometer, or the like is appropriately used.

The control unit 4 includes a calculating unit 41 that calculates the characteristic values on the basis of the value obtained by the measurement using the measuring unit 5, determining unit 42 that determines necessity of operation of the switching unit 2 on the basis of the characteristic values calculated by the calculating unit 41, and a signal generating unit 43 that instructs the degree of opening of each valve (the first valve V1, the second valve V2, the third valve V3, and the fourth valve V4) of the switching unit 2 as an electric signal, on the basis of the determination of the determining unit 42.

In the case of adopting the above configuration, the measuring unit 5 continuously measures characteristic values such as electric conductivity of water, temperature, LSI (Langeliar Saturation Index) and the like. The determining unit 42 in the control unit 4 compares these characteristic values with a predetermined reference value or reference range. When the reference value or the reference range is satisfied, the determining unit 42 determines that the fresh water recovery rate can be increased, and performs the separation of the switchable secondary element E2x using the switching unit 2. Further, a configuration in which the control unit 4 opens and closes the fourth valve V4 to fill the switchable secondary element 12x with the preservative solution may be adopted.

Further, when using the LSI as an indicator, “the case in which the reference value or the reference range is satisfied” corresponds to a case in which the LSI is smaller than the reference value (e.g., smaller than 0). Further, the determination as to whether or not the fresh water recovery rate can be increased is usually performed by checking the presence or absence of scale precipitation of the element using LSI, but the same determination may be made on the basis of the electric conductivity and/or temperature.

Generally, the value of LSI depends on each value of electric conductivity and temperature of water to be measured. Furthermore, the electrical conductivity is determined by the dissolved salt concentration in water (i.e., the concentration of salt dissolved in the ion state as an electrolyte). Further, as the temperature of water increases by 1° C., the value of LSI increases by approximately 1.5×10⁻².

Therefore, after measuring the electric conductivity and the temperature by the measuring unit 5, the calculating unit 41 in the control unit 4 calculates the LSI-converted value by performing calculation on the basis of the characteristic values. The determining unit 42 of the control unit 4 determines whether or not the fresh water recovery rate can increase on the basis of the LSI-converted value.

That is, when using the reference range of the electric conductivity or temperature corresponding to the case where the LSI is smaller than the reference value, the determining unit 42 determines that the fresh water recovery rate can be increased, and the separation of the switchable secondary element E2x using the switching unit 2, and filling of the preservative solution are performed.

According to such a configuration, it is possible to autonomously maximize the fresh water recovery rate in accordance with the quality of the water to be treated SW. In particular, the capability of the water treatment device 1 can flexibly respond to changes in water quality due to seasonal variations or the like.

### INDUSTRIAL APPLICABILITY

According to the water treatment device 1 and the operation method of the water treatment device 1 described above, it is possible to improve the fresh water recovery rate and the operation rate.

### REFERENCE SIGNS LIST

1 Water treatment device
2 Switching unit
3 Preservative solution supply device
4 Control unit
41 Calculating unit
42 Determining unit
43 Signal generating unit
5 Measuring unit
CW1 Primary condensed water
CW2 Secondary condensed water
E1 Primary element
E11 Primary flow inlet
E12 Primary water collection port
E13 Primary fresh water collection port
E2 Secondary element
E21 Secondary flow inlet
E22 Secondary water collection port
E23 Secondary fresh water collection port
E2x Switchable secondary element
FW1 Primary fresh water
FW2 Secondary fresh water
L1 Water intake line
Lc Connection line
Ld1 Primary distribution line
Ld2 Secondary distribution line
Lf1 Primary fresh water line
Lf2 Secondary fresh water line
Lg1 Primary water collection line
Lg2 Secondary water collection line
Lp1 Preservative solution supply line
Lp2 Preservative solution discharge line
P Pump
SW Water to be treated
U1 Primary unit
U2 Secondary unit
V1 First valve
V2 Second valve
V3 Third valve
V4 Fourth valve

1. A water treatment device comprising:
a primary unit having a plurality of primary elements as reverse osmosis membrane devices disposed in parallel to each other to separate water to be treated into primary condensed water and fresh water;
a pump which feeds the water to be treated to the primary unit;
a secondary unit having secondary elements as reverse osmosis membrane devices, the secondary elements being provided in smaller number than the primary elements and disposed in parallel to each other to separate the primary condensed water into secondary condensed water and fresh water; and
a switching unit provided only in the secondary unit among the primary unit and the secondary unit to separate at least one of the plurality of secondary elements so that treatment is disabled.

2. The water treatment device according to claim 1, wherein at least one of the secondary elements includes:
an introduction line which guides the primary condensed water supplied from the primary unit to the secondary element,
a secondary condensed water line through which the secondary condensed water separated from the primary condensed water flows, and
a fresh water line through which the fresh water separated from the primary condensed water circulates, and
the switching unit includes:
a first valve provided on the fresh water line,
a second valve provided on the secondary condensed water line, and
a third valve provided on the introduction line.

3. The water treatment device according to claim 2, further comprising:
a preservative solution supply line provided between the third valve and the secondary element on the introduction line to guide the preservative solution supplied from the outside to the secondary element;
a preservative solution discharge line provided between the second valve and the secondary element on the secondary condensed water line to discharge the preservative solution from the secondary element to the outside; and
a fourth valve provided on the preservative solution discharge line.

4. The water treatment device according to claim 1, further comprising:
a measuring unit which measures characteristic value of at least one of the water to be treated, the primary condensed water, the secondary condensed water, and the fresh water; and
a control unit which controls the operation of the switching unit on the basis of a comparison between a Langeliar saturation index obtained from the characteristic value and a predetermined reference value.

5. The water treatment device according to claim 4, wherein the characteristic value is a temperature or electric conductivity in at least one of the water to be treated, the primary condensed water, the secondary condensed water, and the fresh water, and
the control unit includes a calculating unit which calculates the Langeliar saturation index on the basis of the temperature or the electric conductivity.

6. A method of operating the water treatment device for separating at least one secondary element from the water treatment device according to claim 2, the method comprising:
closing the fresh water line by closing the first valve;
closing the secondary condensed water line by closing the second valve after closing the first valve; and
closing the introduction line by closing the third valve after closing the second valve.
